(19) United States
(12) Patent Application Publication
(10) Pub. No.: US 2006/0266136 A1
(43) Pub. Date: Nov. 30, 2006

(54) Bi-fluorophore marked probes for detecting nucleic acids

(75) Inventor: Holger Winter, Altenberge (DE)

Correspondence Address: ROTHWELL, FIGG, ERNST & MANBECK, P.C., 1425 K STREET, N.W., SUITE 800, WASHINGTON, DC, 20005, US

(73) Assignee: Gnothis Holding AG, Ecublens (CH)

(21) Appl. No.: 10/560,236

(22) PCT Filed: Jun. 8, 2004
(86) PCT No.: PCT/EP04/06180

§ 371 Date: Apr. 28, 2006

(51) Int. Cl. G01D 21/00

(52) U.S. Cl. 73/866.5

(57) ABSTRACT

The present invention relates to 5′-3′-bifluorophore-labelled probes for detecting analytes, in particular nucleic acids, in particular for confocal fluorescence spectroscopy.

The present invention relates to 5′-3′-bifluorophore-labeled probes for detecting analytes, in particular nucleic acids, in particular for confocal fluorescence spectroscopy.

Nucleic acid molecules are usually detected in a sample by means of hybridization using specific probes. One possibility for detecting and quantitatively determining the hybridization products consists in labeling the probes with fluorescent dye groups, with the labeling groups as a rule being bound to the 5′ end of the detection probe. Following excitation with a specific wavelength, the fluorescent labeling groups emit photons which can be detected using suitable detection methods. The appearance of a fluorescent label correlates with the presence in the sample of the nucleic acid to be detected. The number and size of the hybridization products can also be determined using suitable methods.

The number of the photons which are emitted by the labeled probes has a substantial influence on the sensitivity of the detection method. While probes which are labeled with red fluorescent labeling groups in many cases exhibit adequate sensitivity [expressed in IPM (impulses per molecule)], the quantum yield of certain fluorescent dyes is reduced in the green region due to electron transfer processes taking place between nucleobases and the labeling group. In order to decrease these interactions, spacer molecules, e.g. hexaethylene glycol molecules, which result in a slight improvement but not one which is sufficient for many applications, have been placed between the probe sequence and the labeling groups.

The object underlying the present invention was to avoid the disadvantages of the prior art and, in particular, provide probes for detecting analytes, e.g. nucleic acids, with an improved degree of sensitivity.

This object is achieved by means of a probe having the general structural formula (I)
5′-M-(Z)ₙ-X₁-X₂- . . . Xₘ-(Z)_{n′}-M′-3′
wherein X₁, X₂ . . . and Xₘ are in each case an arbitrary nucleotide or nucleotide analog and in which the sequence X₁-X₂- . . . Xₘ is a probe sequence which is capable of binding to an analyte, Z is, in each case independently, a pyrimidine nucleotide or pyrimidine nucleotide analog, M and M′ are fluorescent labeling groups, n and n′ are, in each case independently, integers of from 1 to 15, and m is an integer corresponding to the length of the probe sequence.

The detection probes according to the invention contain a second labeling group at the 3′ end in addition to the fluorescent labeling group at the 5′ end. These two fluorescent dye molecules are separated by means of oligopyrimidine sequences, as spacers, from the probe sequence which hybridizes with the target nucleic acid. The IPM values of the probes according to the invention are up to 10 times higher than those of the probes disclosed in the prior art.

The probes according to the invention can be composed of nucleotide and nucleotide analog building blocks as known from the prior art, for example PNA or LNA building blocks. Preference is given to the units X₁, X₂ . . . and Xₘ, which form the probe sequence which is capable of binding to the analyte, being selected, in each case independently, from units having the general structural formula (II), or salts thereof,

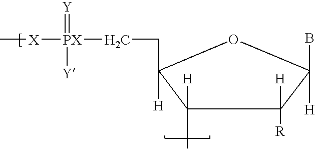

wherein

B is a natural or unnatural nucleobase,

R is a radical which is selected from H, OH, halogen, —CN, —Cl—C₆-alkyl, —C₂—C₆-alkenyl, —C₂—C₆-alkynyl, —O—C₁—C6-alkyl, —O—C₂—C₆-alkenyl, —O—C₂—C₆-alkynyl, —SH, —S—C₁-C₆-alkyl, —NH2, —NH(C₁-C₆-alkyl) and —N(C₁-C₆-alkyl)₂,

—X is, in each case independently, a radical which is selected from —O—, —S—, —NR′— and CR′₂,

—Y is, in each case independently, a radical which is selected from ═O and ═S, and

−Y′is, in each case independently, a radical which is selected from —OR′, —SR′, —(NR′)₂ and —CH(R′)₂,

where R′ is, in each case independently, H or C₁—C₃-alkyl.

The nucleobase B can be a natural nucleobase, e.g. adenine, cytosine, uracil, guanine or thymine, or an unnatural nucleobase, e.g. 2,6-diaminopurine, 7-deaza-adenine, 7-deazaguanine, a 5-modified thymine or cytosine derivative or isoguanine (6-amino-2-hydroxy-purine).

The substituent R at the 2′ position is preferably H, such that the units X₁, X₂ . . . and Xₘ are at least partially 2′-deoxynucleotides. Other preferred meanings for R are alkyl, alkoxy, alkenyl and halogen.

The units of the probe according to the invention are linked by phosphodiester groups or modified phospho-diester groups in which, in the case of the units having the structural formula (II), X is preferably, in each case independently, —O—, —S— or —NH—, Y is preferably, in each case independently, ═O or ═S and Y′ is preferably, in each case independently, —OH, —SH, —NH₂, —CH₃ or —C₂H₅.

In the structural formula (I), Z is a pyrimidine nucleotide or a pyrimidine nucleotide analog, e.g. a thymidine and/or cytidine nucleotide or nucleotide analog. Z is preferably a thymidine nucleotide such that (Z)ₙ and (Z)_{n′} preferably in each case contain at least one thymidine nucleotide. Particular preference is given to Z in each case being a thymidine 2′-deoxy-nucleotide. However, Z can in principle also be a nucleotide analog unit as previously described.

The fluorescent labeling groups of the probe (I) are preferably, in each case independently, selected from rhodamines, fluoresceins, oxazines, cyanines, Bodipy dyes, Alexa dyes, etc. Particular preference is given to oxazines as described in PCT/EP03/02981. Particular preference is given to M and M′ being green fluorescent labeling groups such as rhodamine green, tetra-methylrhodamine, rhodamine. 6G, Oregon green, Bodipy 493 and Alexa 488 whose quantum yield is quenched by electron transfer processes in customary probe constructs.

The fluorescent labeling groups M and M′ are preferably identical. However, M and M′ can also be different in certain embodiments. In this case, M and M′ preferably differ in at least one measured parameter, e.g. emission wavelength and/or decay time, such that it is possible to detect and M and M′ separately.

In the probes (I), the lengths of the spacers n and n′ are, in each case independently, an integer of 1-15, preferably an integer of 3-10, particularly preferably about 5.

The length m of the probe sequence which binds to the analytes is advantageously selected such that specific and detectable binding of the analyte is possible under the prevailing test conditions. m is usually an integer of 10-90, preferably of 12-50.

The invention also relates to the use of one or more probes having the structural formula (I) in a method for detecting an analyte, e.g. a nucleic acid, in a sample, with the method comprising detecting a binding of one or more probes to the analyte. The method preferably comprises detecting a hybridization of one or more probes with a target nucleic acid. If appropriate, the method can comprise quantitative detection with regard to the number of hybridization products in the sample and/or the size of the hybridization products. However, other detection methods are also possible, for example detecting the binding of one or more probes to a protein, such as the binding of aptamers to proteins.

The outstanding sensitivity of the detection probes according to the invention also enables them to be used in connection with very low analyte concentrations. Thus, when the probes according to the invention are used, adequate detection sensitivity is achieved even when the concentration in the sample of the analyte to be detected is ≦10⁻⁹ M. The concentration of the analyte to be detected is preferably from 10⁻¹⁰ to 10⁻¹⁵ M. The high sensitivity of the probes according to the invention enables detection to take place at such low concentrations even without any preceding amplification of the analyte in the sample. The analyte to be detected is preferably a nucleic acid, e.g. DNA or RNA of any origin, which can originate, for example, from prokaryotes, in particular pathogenic prokaryotes, Archea or eukaryotes, in particular mammals, such as humans. Particular preference is given to the nucleic acid to be detected originating from a human sample, e.g. a body fluid, a tissue sample, etc.

In a preferred embodiment, the nucleic acid to be detected is an RNA from a biological sample or an unamplified cDNA which is synthesized therefrom. In another preferred embodiment, the nucleic acid to be detected is an unamplified genomic DNA.

The fluorescence of the probes according to the invention can be detected using any arbitrary measurement method, e.g. using site-resolved and/or time-resolved fluorescence spectroscopy. Preference is given to using a measurement method which is able to detect fluorescence signals down to single photon counting in a very small volume element.

For example, the detection can be effected by means of confocal single molecule detection, as, for example, by means of fluorescence correlation spectroscopy, where a very small, preferably confocal volume element, for example from 0.1×10⁻¹⁵ to 20×10¹² l of the sample liquid, is subjected to the excitation light from a laser, which light stimulates the fluorescent labels which are present in this measured volume to emit fluorescence radiation, with the fluorescence radiation which is emitted from the measured volume being measured by means of a photodetector and it being possible to generate a correlation between the chronological change in the measured emission and the relative mobility of the molecules involved such that, when the dilution is appropriately great, individual molecules can be identified in the measured volume.

The reader is referred to the disclosure of European patent 0 679 251 for details with regard to implementing the method and technical details with regard to the devices used for the detection. Confocal single molecule determination is also described in Rigler and Mets (Soc. Photo-Opt. Instrum. Eng. 1921 (1993), 239 ff.) and Mets and Rigler (J. Fluoresc. 4 (1994), 259-264).

Alternatively or in addition the detection can also be carried out by means of a time-resolved decay measurement, what is termed time gating, as described, for example, by Rigler et al., “Picosecond Single Photon Fluorescence Spectroscopy of Nucleic Acids”, in: “Ultrafast Phenomena”, D. H. Auston, Ed., Springer 1984. In this method, the fluorescent molecules within a measured volume are excited and then, preferably after a time delay of ≧100 ps, a detection interval is opened at the photodetector. In this way, it is possible to keep background signals which are generated by Raman effects sufficiently low to make possible a detection which is essentially interference-free.

Particularly preferred detection methods and devices are described, for example, in PCT/EP01/07190, PCT/EP01/05408, PCT/EP01/05410, PCT/EP01/05409, PCT/EP01/13120, PCT/EP02/02582, PCT/EP02/05866, PCT/EP02/13390, PCT/EP02/09610 and PCT/EP03/02713.

Particular preference is given to the method being carried out such that several fluorescence-labeled probes, with at least one probe being a probe according to the invention and with each probe having a different sequence and different labeling groups, being used for detecting a single analyte. In this case, the presence of the analyte in the sample is preferably determined by the existence of a correlation between the appearance of different probes corresponding to simultaneous binding to the analyte. Preference is given to carrying out such a method as a crosscorrelation determination as described, for example, in Schwille et al. (Biophys. J. 72 (1997), 1878-1886) and Rigler et al. (J. Biotechnol. 63 (1998), 97-109). Other preferred detection methods include coincidence analysis, principle component analysis (PCA), fluorescence intensity distribution analysis (FIDA) and fluorescence intensity multiple distribution analysis (FIMDA).

In a particularly preferred embodiment, use is made of a probe combination which comprises a doubly labeled probe according to the invention which carries green fluorescent labeling groups and a probe which carries one or more red fluorescent labeling groups.

Finally, the present invention relates to a method for detecting an analyte in a sample, which method comprises bringing the sample into contact with one or more probes according to the invention under conditions under which the one or more probes can bind to the analyte to be detected and then determining whether binding takes place or not.

Preference is given to the analyte being a nucleic acid and to the detection comprising a hybridization of the one or more probes with the nucleic acid to be detected. Particular preference is given to the nucleic acid to be detected not being subjected to an amplification, e.g. a PCR, before being brought into contact with the probe or probes.

The following example is also intended to explain the invention.

### EXAMPLE

### Using bifluorophore-labeled oligonucleotides

The outstanding sensitivity of the detection probes is made clear in that which follows. Two different green probes having identical sequences are used. In the first case, the probe is a probe which is singly labeled 5′ with rhodamine green while, in the second case, the probe is a probe according to the invention which is doubly labeled 5′ and 3′ with rhodamine green and which contains a thymidine spacer of in each case 5 nucleotides in length both for the 3′ dye and for the 5′ dye. The sequence of the detection probe is specific for the PGK-1 sequence (accession number: V00572). In order to determine the lower detection limit, a green labeled probe and a red labeled probe (likewise PGK-1 specific) are in each case hybridized simultaneously, in solution, to a PGK-1-specific cDNA fragment (length: 969 nt). The hybridization takes place in 6×SSC, 0.06% NP40 buffer at 60° C. over a period of 8 hours. Different concentrations of the PGK-1 fragment (0.0 nM PGK-1 to 2 nM PGK-1) are used in this connection. The hybridization products are analyzed by means of cross-correlation spectroscopy.

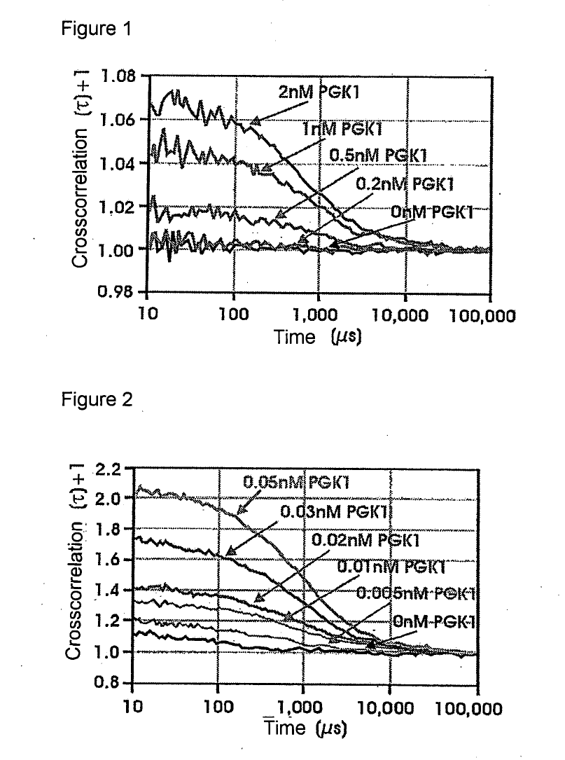

The result of this analysis is shown in FIGS. 1 and 2. In FIG. 1 (comparison example), the combination of a green probe which is single labeled 5′ and a red probe which is singly labeled 5′ for detecting PGK-1 cDNA at concentrations of 2 nM, 1 nM, 0.5 nM, 0.2 nM and 0 nM is investigated.

In FIG. 2 (invention example), the combination of a green probe according to the invention which is doubly labeled 5′ and 3′ and which has thymidine spacers and a red probe which is singly labeled 5′ for detecting PGK-1 cDNA at concentrations of 0.05 nM, 0.03 nM, 0.02 nM, 0.01 nM, 0.005 nM and 0 nM is investigated.

The probe concentration in FIG. 1 is 2.0 nM while that in FIG. 2 is 0.1 nM.

A comparison of FIGS. 1 and 2 impressively demonstrates the advantages of the detection probes according to the invention. Whereas the lower detection limit for the singly labeled probe is 0.2 nM PGK-1 (FIG. 1), the sensitivity can be markedly increased to 5 nM PGK-1 when using the doubly labeled probe (FIG. 2).

1. A probe having the general structural formula (I)
5′-M—(Z)ₙ-X₁-X₂- . . . Xₘ-(Z)_{n′},-M′ -3′
wherein X₁, X₂ . . . and Xₘ are in each case an arbitrary nucleotide or nucleotide analog and in which the sequence X₁-X₂- . . . Xₘ is a probe sequence which is capable of binding to an analyte,
Z is, in each case independently, a pyrimidine nucleotide or pyrimidine nucleotide analog,
M and M′ are fluorescent labeling groups,
n and n′ are, in each case independently, integers of from 1 to 15, and
m is an integer corresponding to the length of the probe sequence.

2. The probe as claimed in claim 1, characterized in that X₁, X₂ . . . and Xₘ are selected, in each case independently, from units having the general structural formula (II) or salts thereof:
wherein
B is a natural or unnatural nucleobase,
R is a radical which is selected from H, OH, halogen, —CN, —C₁—C₆-alkyl, ↑C₂—C₆-alkenyl, —C₂—C₆-alkynyl, —O—C₁—C₆-alkyl, —O—C₂—C₆-alkenyl, —O—C₂—C₆-alkynyl, —SH, —S—C₁—C₆-alkyl, —NH₂, —NH(C₁—C₆-alkyl) and —N(C₁—C₆-alkyl)₂,
—X is, in each case independently, a radical which is selected from —O—, —S—, —NR′—and —CR′ ₂-,
—Y is, in each case independently, a radical which is selected from ═O and ═S, and
—Y′ is, in each case independently, a radical which is selected from —OR′, —SR′, —(NR′)₂ and —CH(R′)₂,
where R′ is, in each case independently, H or C₁—C₃-alkyl.

3. The probe as claimed in claim 1, characterized in that X₁, X_{2 . . .} and Xₘ are 2′-deoxynucleotides.

4. The probe as claimed in claim 1, characterized in that Z is selected from thymidine nucleotides or nucleotide analogs and/or cytidine nucleotides or nucleotide analogs.

5. A probe as claimed in claim 1, characterized in that at least one Z is a thymidine nucleotide or nucleotide analog.

6. The probe as claimed in claim 1, characterized in that Z is in each case a thymidine 2′-deoxynucleotide.

7. The probe as claimed in claim 1, characterized in that M and M′ are selected, in each case independently, from rhodamines, fluoresceins, oxazines, cyanines, Bodipy dyes and Alexa dyes.

8. The probe as claimed in claim 1, characterized in that M and M′ are selected from green fluorescent labeling groups.

9. The probe as claimed in claim 1, characterized in that M and M′ are identical.

10. The probe as claimed in claim 1, characterized in that M and M′ are different.

11. The probe as claimed in claim 1, characterized in that n and n′ are, in each case independently, integers of from 3 to 10.

12. The probe as claimed in claim 1, characterized in that m is an integer of 10-90, preferably of 12-50.

13. The use of one or more probes as claimed in claim 1 in a method for detecting an analyte in a sample.

14. The use as claimed in claim 13, characterized in that the concentration in the sample of the analyte to be detected is ≦10⁻⁹ M.

15. The use as claimed in claim 13 characterized in that the analyte is a nucleic acid.

16. The use as claimed in claim 15, characterized in that the nucleic acid to be detected is an RNA from a biological sample or an unamplified cDNA which is synthesized therefrom.

17. The use as claimed in claim 15, characterized in that the nucleic acid to be detected is an unamplified genomic DNA.

18. The use as claimed in claim 13 in fluorescence correlation spectroscopy (FCS).

19. The use as claimed in claim 13, characterized in that several probes in each case having a different sequence and different labeling groups are used for detecting a single analyte.

20. The use as claimed in claim 19, characterized in that the detection comprises a crosscorrelation determination.

21. A method for detecting an analyte in a sample, comprising bringing the sample into contact with one or more probes as claimed in claim 1 under conditions under which the one or more probes can bind to the analyte to be detected and then determining whether binding takes place or not.

22. The method as claimed in claim 21, comprising the detection of a nucleic acid by means of hybridization.

23. The method as claimed in claim 22, characterized in that the nucleic acid to be detected is not amplified before being brought into contact.
